(19) United States
(12) Patent Application Publication
(10) Pub. No.: US 2007/0103901 A1
(43) Pub. Date: May 10, 2007

(54) Light for connection to a conventional socket having a plurality of light emitting diodes on a first side of the illumination core and a second plurality of light emitting diodes on the second side thereof

(76) Inventor: Hubert M. Reid, Bozeman, MT (US)

Correspondence Address: LAURENCE R LETSON, P O BOX 4129, LEXINGTON, KY, 40544, US

(21) Appl. No.: 11/270,739

(22) Filed: Nov. 9, 2005

(51) Int. Cl. F21V 33/00

(52) U.S. Cl. 362/234

(57) ABSTRACT

An light emitting diode (LED) light is disclosed wherein the light is provided with a standard base for placement into a socket formerly occupied by a filament light. The LED light incorporates both a first plurality of LEDs projecting illumination from the circuit board in a forward direction and a second plurality of LEDs projecting illumination rearwardly in order to illuminate the support member through which the light projects. The circuit board has two planar surfaces to support and position the LEDs. This LED support is positioned on the outer end of a hollow tube member to form an illumination core. The hollow tube member or the LED support contains the electronic wiring, connected between the base, circuit components, and the LEDs to illuminate the LEDs.

### FIELD OF THE INVENTION

This invention relates to the field of illumination and more particularly to Light Emitting Diodes (LEDs) light devices wherein the LEDs are substituted for the more conventional filaments of the prior art while retaining the use of a standard bulb base.

### BACKGROUND OF THE INVENTION

In the field of illumination, there are many different standards and requirements. Within a light bulb, the illuminating element not only has an illumination standard or requirement but also may be tailored to a specific “end-usage” need. Due to the diverse usages and customers, lighting products must be tailored to specific requirements for each illumination situation. This requirement demands that the illumination source not only be tailored to the source of electrical power provided and utilized but also to be effective in providing the illumination required.

With respect to these illumination requirements, the discussion will be directed to the illumination of surfaces which are generally flat but also may include some surfaces which have relatively shallow concave or convex surfaces. As well as delivering light from the bulb directly to the observer's eye, these planar, concave or convex surfaces usually require a level of illumination projected onto the surface itself in addition to light projected outward from a light bulb.

“Attraction by lights or lighting” is important for business or safety reasons. Initially catching the attention of passers-by is vital to the success of carnival rides or attractions, billboards, marquees or booths. Each is an example of a customer situation of planar surfaces as well as minor concave and convex surfaces which requires illumination.

The operation of such an object or facility seeks “attention getting” illumination, not merely “flat illumination.”Because the goal of the lighting is to attract the eye of the observer and hold the attention of the viewer, it is important that a light bulb provide an illumination both to the background from which the light bulb is extended and outwardly from the bulb directly toward the observer's eye. The light bulb must provide illumination in a first direction that is directed away from the light source, toward an open space that may be occupied by observers.

Similarly, it may be desired that the backdrop from which the light bulb extends will be illuminated and reflect that light from the backdrop itself.

In the prior art, illumination was provided by an incandescent bulb of low wattage, contained within a colored plastic shell or over-shroud that would act to provide the color for each light as needed. If compact enough to fit within the plastic shell, the same colored plastic shell or over-shroud is usable to color light from any source. The filament of an incandescent bulb radiates light in all directions and illuminates the background as well as projects illumination toward the open space away from the bulb.

An incandescent bulb of the prior art typically consumes about 10-12 watts of electrical energy; and, whenever used as an element of a large fully lighted marquee display, this wattage will result in the consumption of large amounts of electrical current which significantly magnifies the cost of operating a bank of incandescent bulbs.

In a carnival usage environment, the high level of energy consumption requires a power source. A connection to a power grid such as a city power network is preferable but such electrical power may not be available. Generators form an alternative power source, but the cost of a large generator can be very expensive to purchase and operate.

In addition to the “handling issues” associated with “normal usage” of a bulb itself, the erection and/or transport of a structure upon which the bulb is mounted may subject an incandescent bulb to forces sufficient to break its filament within the bulb due to jars, bumps and mishandling of the structure. Bulb replacement requires the removal of both the over-shroud and bulb before the actual replacement of the bulb and its over-shroud. This is a labor intensive activity resulting in higher related costs. Because each light is used on a structure which is regularly disassembled and loaded for transit on a vehicle, then reassembled at a new site, the costs of additional personnel and related expenses due to broken filaments etc. can be considerable.

The prior art discloses the types of bulbs or lights that have been used in various environments to solve the requirements of various installations are discussed below:

U.S. Pat. No. 4,211,955 issued to Ray illustrates a solid state light bulb operable on either A.C. or D.C. power. This patent illustrates the circuitry necessary to operate the solid state bulb.

U.S. Pat. No. 5,463,280 issued to Johnson discloses an elongated bulb with a circuit board extending the length of the lamp. The circuit board has mounted on both sides a plurality of LEDs illuminating from the sides of the bulb.

U.S. Pat. No. 5,506,760 issued to Geibler et al. discloses a lamp with an interior channeled member and a plurality of LEDs resident in the channel to direct the light from the LEDs.

U.S. Pat. No. 5,575,459 issued to Anderson discloses a printed circuit board supporting a plurality of LEDs with the circuit board extending from the base outward to the tip of the lamp. The LEDs are located on one side of the circuit board.

U.S. Pat. No. 5,726,535 issued to Yan discloses a bulb containing a pair of circuit boards extending from the base to the end of the glass envelope. The circuit boards extend from the base the length of the bulb.

U.S. Pat. No. 5,821,695 issued to Vilanilam et al. discloses an explosion-proof pilot light using LEDs encapsulated within a chamber.

U.S. Pat. No. 5,850,126 issued to Kanbar discloses a flat panel supporting a plurality of LEDs on one side thereof and as being useful as a bulb in a traffic light.

U.S. Pat. No. 5,949,347 issued to Chen H. Wu discloses a light emitting diode bulb incorporating a printed circuit board extending form the base of the lamp and bearing LEDs on the surface thereof and a connection with the base which permits turning the LED array to properly position the LEDs.

U.S. Pat. No. 6,036,336 issued to Chen H. Wu teaches a flat panel covered with LEDs to form the face of a light that can be inserted into a traffic light. The patent to Wu further discloses alternative arrangements or layouts in order for the LEDs to convey instructions for pedestrians.

U.S. Pat. No. 6,149,283 issued to Conway et al teaches an LED light bulb having a reflector in the shape of a concave surface and variable brightness controls to control the intensity of the light emitting from the lamp.

U.S. Pat. No. 6,184,628B1 issued to Ruthenberg illustrates a light bulb having a plurality of LEDs arranged on one side of a flat circuit board to project the light out through the bulb face directly into a swimming pool.

U.S. Pat. No. 6,543,978B1 issued to Huang discloses an LED light bulb with LEDs mounted on a stretchable frame that is adapted to be elastically deformed in order to insert the string of LEDs into the narrow neck of a rigid glass bulb during assembly.

U.S. Pat. No. 6,796,698B2 and its U.S. Patent Application Publication No. US2003/0185005A1, granted to Simmers et al., disclose a light emitting diode-based signal light wherein the bulb disclosed projects the light from the LEDs mounted within the bulb to impinge on the reflective surface of an element designed to redistribute and redirect the light.

U.S. Patent Application Publication No. US2002/0117692A1 by Lin discloses a moisture-resistant LED vehicle light bulb having a base, a casing and a circuit board supporting and supplying the electrical power to a plurality of LEDs mounted on the circuit board. All LEDs project light in a direction away from the base of the LED light bulb.

U.S. Patent Application Publication No. US2002/0126491A1 by Chen illustrates a LED bulb with a single LED positioned within its globe and supported by a circuit board. The bulb is provided with a screw base which dictates that the LED only illuminate only in a direction substantially parallel to the axis of the screw base.

U.S. Patent No. Application Publication No. US2003/0185020A1 by Stekelenburg discloses a single LED night light bulb having a single LED positioned coaxial with the base member.

U.S. Pat. No. 6,685,339B2 and

U.S. Patent Application Publication No. US2003/0151917A1 by Daughtry et al. disclose a sparkle light bulb which has the capability of operating in a color wash mode or a color dance mode. The bulb comprises a plurality of colored LEDs, and LEDs of a given color can be controlled to illuminate or turn off as desired. The LEDs are arranged on a flat surface and are disposed in a position that all light is projected outwardly from the light and not allowed to illuminate in any other direction.

U.S. Patent Application Publication No. US2005/0030761A1 by Burgess discloses an automotive light bulb with LEDs disposed on both sides of an electronic circuit board that provides circuitry to operate the LEDs.

U.S. Patent Application Publication No. US2005/0174769A1 by Yong et al. discloses a light bulb which has a plurality of strips supporting LEDs on one side thereof, with the strips positioned over a form that positions the LEDs to illuminate outwardly from the semi-spherical form.

U.S. Patent Application Publication No. US2005/0180137A1 by Hsu illustrates an LED light bulb including a control board and an LED within a bulb cover. The control board includes a circuit for conversion of the AC power to DC power and a circuit for control of the LED. The circuit board is positioned to project illumination outward from the circuit board, to interact with and a reflector to direct the light in a cone of light directed away from the light and away from the base of the LED light.

### SUMMARY OF THE INVENTION

The invention is a light having a plurality of Light Emitting Diodes, herein referred to as LEDs, mounted upon a support member. A first plurality of LEDs is situated on the top face of an illumination core mounted in the center of the light. The illumination core has a circuit board to support the LEDs and a tube of a cylindrical shape, the base of which is attached to a threaded base member for support.

The distal portion of the illumination core is comprised of a circular circuit board with a diameter larger than the cylindrical support member. The circuit board is permanently attached to the cylindrical support member. The circuit board supports both a first plurality of LEDs on its outer surface and a second, smaller plurality of LEDs on its lower surface surrounding the central member.

The base of the light is a standard threaded cup-shaped member with electrical contacts formed in the bottom of the threaded member and the threaded member itself. However, other standard bases could be incorporated. These bases could be a pin-and-socket type base, if desired, or any other type base which allows the removal and reinsertion of a light into a socket.

The cylindrical illumination core is supported within the base of the LED light and further supports or contains the electrical elements of the circuit which changes the standard 120V AC voltage to the required DC voltage for the LED light. The voltage required for the LED light is such that the 120V power is rectified to produce a direct current of about 0.2 milliamps to power the LEDs within the light.

This LED light is very efficient from the standpoint of cost of operation. As one may note, the power required to operate the subject light is in fact diminimus as compared to an incandescent light for the same usage.

This Summary of the Invention is provided to summarize the construction and use of the invention and provide a general understanding of the invention to the reader and is not intended to be of a limiting nature, inasmuch as the invention is solely limited by the claims attached hereto.

### OBJECTS OF THE INVENTION

It is an object of the invention to illuminate an area around the base of a LED light supported on a backdrop using a single LED light which may be substituted for a filament or incandescent light bulb.

It is another object of the invention to provide light from an LED light in two directions so as to advantageously illuminate a region of a backdrop encircling the base of the bulb as well as projecting light from some of the light sources outwardly and away from said bulb.

It is an additional object of the invention to support a plurality of LEDs on a first planar surface of an illumination core to illuminate a region of a background surface and to support on a second planar surface parallel to the first planar surface of an illumination core to provide direct illumination in a outward direction from said light.

It is still another object of the invention to provide a light to illuminate a backdrop surface and to project light outward into open space using a first and second plurality of LEDs mounted within a light.

### DESCRIPTION OF THE DRAWINGS

FIG. 1 is an elevation depiction of the LED light of the present invention.

FIG. 2 is a top view of the LED light of the present invention.

FIG. 3 is a section view along line 3-3 in FIG. 1.

FIG. 4 is a section view along line 4-4 in FIG. 1.

FIG. 5 is a schematic circuit diagram illustrating the several components for controlling the voltage applied to the LEDs within the illumination core.

These figures are presented to provide a basis for the understanding of the invention along with the detailed description to follow. These figures are not provided nor form a basis upon which to limit the invention in any manner.

### DETAILED DESCRIPTION OF THE BEST MODE OF THE PREFERRED EMBODIMENT OF THE INVENTION

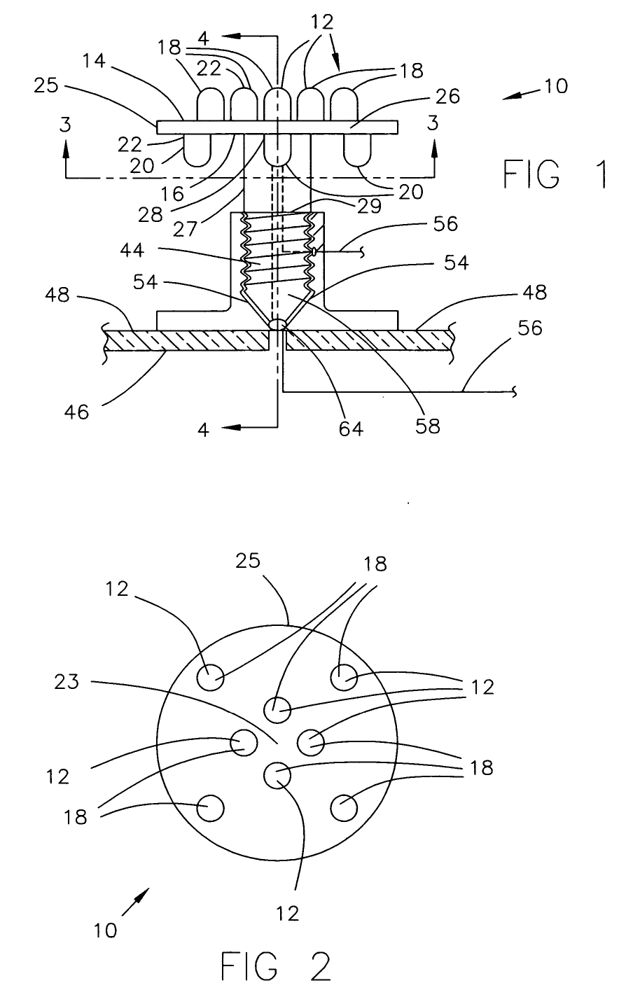

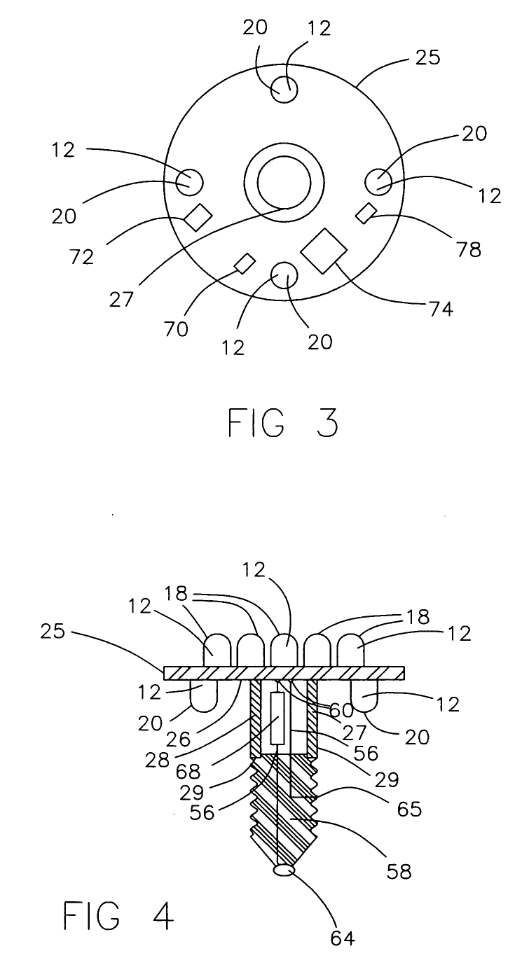

Referring initially to FIGS. 1, 2 and 3, the LED light 10 of the invention is shown containing twelve LEDs 12 arranged on two parallel surfaces 14, 16 of the circuit board 26 within the light 10. These LEDs 12 are divided into a first plurality 18 of LEDs 12 and a second plurality 20 of LEDs 12. The circuit board 26 has the first plurality 18 of LEDs 12 mounted on the front surface 14 or top surface 14; and, the second plurality of LEDs 20 are mounted on the underside 16 or backside surface 16 of circuit board 26.The axes of the LEDs 12 are all positioned with the light emitting portion 22 thereof protruding above the circuit board 26 of the LED light 10. The circuit board 26 is attached at the distal end 28 of tube 27.

The mounting of the LEDs 12 with the light emitting portion 22 of LEDs 12 in the first plurality 18 of the LEDs 12 directed away from base 44 of light 10 will provide no illumination in the direction of base 44. The second plurality 20 of LEDs 12 will provide the desired backside illumination toward light base 44 and therefore illuminate the surface area 48 of support structure 46 or member 46 for socket 54. Support board or structure 46 provides support to a standard light socket 54. In turn, standard light socket 54 provides support to light 10.

In order to illuminate a small portion of surface 48 of support member 46 of the circuit board 26, the LEDs 12 of the second plurality 20 are aimed parallel to the axis 31 (as seen in FIG. 4) of tube 27 and light 10 which lies perpendicular to the circuit board 26. This illuminating of the support member 46, typically a sheet of metal 46 or a portion of a metal structure 46, will add to the illumination from the LEDs 12 forming the first plurality of LEDs 18 and the reflection of the light will be visible from the region in front of the LED light 10.

Support structure 46 can be preferably a white, highly reflective material such as paint or other reflective material. Surface 48 provides the needed reflective surface for the light emitted by the LEDs 12 on the underside 16 of the disc-shaped circuit board 26.

The tube 27 supporting the circuit board 26 is joined to the disc-shaped circuit board 26 by adhering the distal tube end 28 to the backside 16 of circuit board 26 at joint 38.

The electrical power is delivered to the circuit board 26 by a pair of electrical conductors 56 or leads 56 which extend from the base 44 through tube 27, to the distal tube end 28, and further to the connections 60 on the circuit board 26. As seen in FIG. 4, these leads 56 are soldered to the base 44 and extend through the hollow center of the tube 27.

Tube 27 must be anchored to stabilize the LEDs 12 and provide balanced lighting of the support structure 46. Support for the tube 27 is provided by potting the interior of the light base 44 and inserting tube 27 into potting material 58, deposited into light base 44. The potting material 58 is a non-conductive material which sets up and hardens to act as an insulator and a rigid support for the proximal end 29 of tube 27. The potting material 58 can be an epoxy resin which sets up or hardens over a short period of time.

The LEDs 12 on the top surface 14 of circuit board 26 may be a mixture of wide angle and narrow angle LEDs 18. The wide angle LEDs 18 are located at or near the edge 25 of the circuit board 26; the narrow angle LEDs 18 are closer to the center 23 of circuit board 26.

As described in this specification, LED 10 consumes approximately 0.02 watts of power during normal operation. This low power consumption of a LED light 10, compared to that of an incandescent light bulb, is a mere fraction of the power consumed by a filament bulb. A filament bulb typically consumes 10-12 watts of power. As on a marquee, lighted sign, carnival attraction or other similar uses, usage of many LED lights 10 provides an opportunity to replace incandescent bulbs and avoid the unnecessary consumption of power, thus reducing a significant cost of operation.

This LED light 10 may be substituted to fill a position for an incandescent prior art bulb within a display without concern about the intermixing of the two types of lights connected on an extension cord or circuit.

The lighted sign, carnival attraction or carnival ride environment and safety will be greatly improved due to the reduced electrical load of the LEDs 12. The lower electrical load used will reduce the number of extension cords needed, another safety benefit. The electrical load of a large number of these LED lights 10 may permit a larger number of LED lights 1O to be connected to a single electrical source with a single circuit breaker or fuse. The same number of incandescent light bulbs would approach the current limit of a circuit breaker very quickly.

Further, as the control for the voltage provided to the LEDs 12 resides on the circuit board 26 of light 10, usage of LED light 10 can be and is very advantageous. It may be used to replace an inoperative incandescent bulb without alternations having to be made to accommodate a LED light 10, utilizing the same standard socket 54. This replacement is on a one-for-one basis and is simple as well as easy to perform.

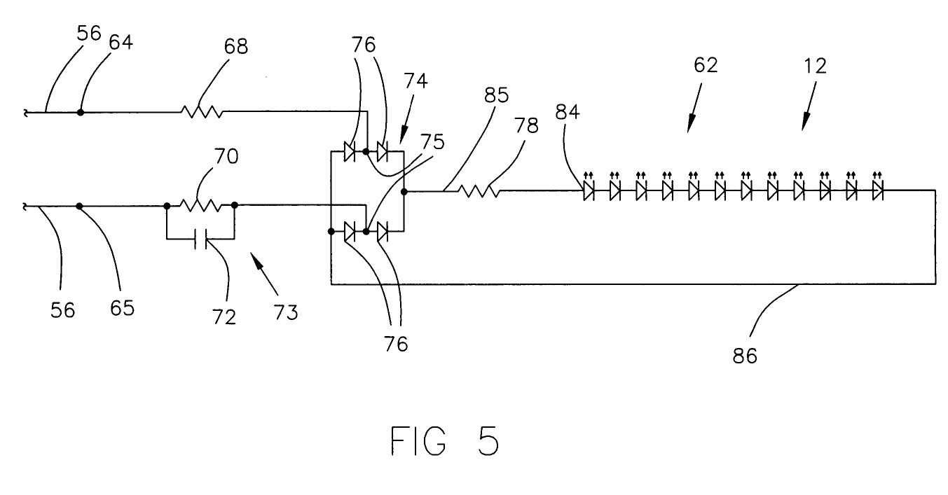

Referring to FIG. 5, a circuit diagram of the circuit 62 on circuit board 26, the 120 v AC power is supplied to circuit 62 by leads 56 across terminals 64,65.

Resister 68 is connected with the first terminal 64, and resister 70 is connected with the second terminal 65. To form a filter 73, resister 70 is connected in parallel with capacitor 72. The outputs of resister 68 and filter 73 are each connected to a mid-point 75 of each separate side of a rectifier bridge 74. Rectifier bridge 74 is composed of two pairs of diodes 76.

Rectifier bridge 74 may be replaced by an integrated circuit element or equivalent to convert the A.C. voltage at terminals 64, 65 to D.C. voltage at rectifier bridge 74 midpoint contacts 75.

The output of rectifier bridge 74 is coupled through a current limiting resister 78 to input 84 of serially connected LEDs 12. The output of the LEDs 12 is connected to each pair of diodes 76.

As seen in FIG. 5, the various components of control circuit 62, labeled 64 through 86, are mounted on the bottom surface 16 of circuit board 26 along with a second plurality of LEDs 20., with the exception of the resister 68. Resister 68 is preferably located within the tube 27 and is connected to segments of lead 64.

An alternative would be to place all circuit components and connections 64 through 86 on a small circuit board (not shown) and insert it into tube 27 prior to potting the base 44 with insulative material 58.

The proximal end 29 of tube 27 is inserted into the insulative material 58, and the insulative material 58 within base 44 is allowed to set up to become hardened or rigid. Base 44 fits into the socket 54, which is electrically supplied by electrical leads 57 or conductors 57.

The rectifier bridge 74 may be replaced by its equivalent by substitution of an integrated circuit to perform the rectification of the A.C. voltage to provide a D.C. voltage to the LEDs 12 connected in series.

It will be apparent to the reader that the invention disclosed herein and claimed in the claims to follow has more than an illumination benefit, as discussed above, but also an economic benefit in that a power source will not need to supply as much electrical power as previously required, which will result in lower electrical power expenses.

It should be noted that minor changes in or modifications to the invention will become apparent to the reader hereof and are contemplated to be within the scope of this invention and covered by the claims hereof.

The Detailed Description of the Invention describes the best mode of the preferred embodiment of the invention and provides the reader with the information necessary to practice the invention. This Detailed Description of the Invention is not provided to form a basis for narrowing the scope of the invention. The invention described herein is to be limited only by the attached claims.

I claim:

1. A light for illuminating an area surrounding a base member and further illuminating by projecting light away from said light and said base member comprising:
a standard base member for connecting said light to a source of electrical power;
said standard base member connected electrically to a pair of electrical conductors;
an illumination core comprising a hollow tube and a circuit board;
said hollow tube, having an axis extending through said hollow tube, having a proximate end and a distal end;
said proximal end of said hollow tube disposed within said electrical base member;
said pair of electrical conductors extending through said hollow tube;
a solid insulating material filling said electrical base and securing said hollow tube to said standard base;
a plurality of electrical components electrically interconnected with other electrical components of said plurality of electrical components for controlling electrical energy supplied from said electrical base through said pair of electrical conductors to said interconnected plurality of electrical components;
a first plurality of light emitting diodes,
a second plurality of light emitting diodes;
said circuit board having a planar bottom surface and a planar top surface for supporting said first plurality of light emitting diodes on said top surface and for supporting said second plurality of light emitting diodes on said bottom surface;
said first plurality of light emitting diodes arranged to project light in a direction substantially perpendicular to said planar top surface;
said second plurality of light emitting diodes arranged to project illumination in a direction away from said planar bottom surface;
said interconnected plurality of electrical components attached to said pair of electrical conductors;
said interconnected plurality of electrical components being further electrically connected to said first and said second pluralities of said light emitting diodes to provide illumination in two directions for the purpose of illuminating a surface surrounding the base of said light and for providing illumination away from said base and said circuit board to illuminate in a direction away from said circuit board and toward said base.

2. The light of claim 1 wherein said plurality of interconnected electrical components is further connected to said first plurality and said second plurality of light emitting diodes so that each of the said first and second plurality of light emitting diodes is electrically connected in series to all other said light emitting diodes in said light.

3. The light of claim 2 wherein said light emitting diodes are resident on said first planar surface and are oriented in a direction substantially perpendicular to said first planar surface.

4. The light of claim 2 wherein said light emitting diodes are resident on said second planar surface are oriented in a direction substantially perpendicular to said second planar surface.

5. The light of claim 2 wherein electrical components are connected to a voltage reduction element; a voltage rectifier and current limiter.

6. The light of claim 5 wherein said voltage reduction element is housed within said tube and said voltage reduction element and connected within one of said voltage conductor conductors intermediate said base and said voltage rectifier.
